(19) United States
(12) Patent Application Publication
(10) Pub. No.: US 2015/0120903 A1
(43) Pub. Date: Apr. 30, 2015

(54) System for monitoring XMPP-based communication services

(71) Applicants: Oleg Y. Zakharov, Concord, CA (US); Robin Chang, Concord, CA (US)

(72) Inventors: Oleg Y. Zakharov, Concord, CA (US); Robin Chang, Concord, CA (US)

(73) Assignees: KYOCERA Document Solutions Development America, Inc., Concord, CA (US); KYOCERA Document Solutions Inc., Osaka (JP)

(21) Appl. No.: 14/062,853

(22) Filed: Oct. 24, 2013

(51) Int. Cl. H04L 12/26

(52) U.S. Cl. CPC H04L 43/04
USPC 709/224

(57) ABSTRACT

Monitoring a communication-based system, comprising: communication service supporting XMPP communication with remote devices; device management applications; external, independent monitoring service monitors the communication-based system; XMPP clients; sending and receiving XMPP messages; and analytical component analyzes XMPP messages to determine status of the system, to possibly restart the communication service if the current response time is below a threshold. Methods include monitoring API and XMPP format comprising monitoring request with name of command to receive performance metrics, and monitoring response that comprises performance metrics; <monitoring_request> and <monitoring_response> tags; XMPP messages comprising real command, not merely watching or monitoring processes; availability matrix and statistical data in a database; availability metrics is percentage of time when the communication service is available, in comparison to the time while it is unavailable or shut down; and performance metrics is number of messages processed in a unit of time and response time of the communication service.

### FIELD OF THE INVENTION

This invention relates to reliability of networked systems, and more particularly to methods of monitoring XMPP-based communication services.

### BACKGROUND OF THE INVENTION

In currently used computing systems, as the number of various devices increases both in number and complexity, the reliability and availability of networked systems have become an issue. Reliability is defined as the ability of a system or component to perform required functionality under specific conditions for a long period of time. Reliability is theoretically defined as the probability of failure over specific period of time. In this case, a ‘failure’ is defined as a time when system is not available to perform required functionality. To minimize time when system or component is unavailable many engineering discipline offers mechanism of recovery. Recovery or self-recovery is a mechanism when system or component could start working again after failure. The present invention arose out of the above perceived needs and concerns associated with reliability and availability of networked systems, and the present invention presents and proposes novel and effective methods of monitoring XMPP-based communication services.

### SUMMARY OF THE INVENTION

The present invention aims to provide a method of monitoring a communication service and system automatically defining service availability as result of reaction on the communication service responses in real time.

There are three major parts involved in the following description of the present invention:

(a). Communication service that supports XMPP-based communication with remote devices. Communication service is part of any kind of Device Management applications. In this invention, each Device Management application does not present any specifications except to be able to react on XMPP messages.

(b). Monitoring Service that is a key component in this invention. Monitoring Service is able to communicate with Communication Service via XMPP by sending and receiving specific XMPP messages.

(c). Analytical component that collects statistic of communication between Communication Service and Monitoring Service. Analytical components allow and enable building of statistical matrix (availability matrix and metrics) and make a decision if Communication Service needs to be restarted.

A preferred embodiment of the present invention presents a method comprising the broad steps of:
1. Communication service supports XMPP-based API to provide short time transactional statistics.
2. Monitoring service uses or consumes XMPP-based API to collect transactional statistics on periodical basis.
3. Monitoring service calculates matrices, measure thresholds.
4. Monitoring service is able to restart Communication service based on calculated rules.

### DESCRIPTION OF THE DRAWINGS

FIG. 1 is a simplified block diagram showing processing systems, components, and devices of a networked system, in accordance with a preferred embodiment of the present invention.

FIG. 2A is a simplified block diagram of document processing systems and devices on a network of an organization, in accordance with a preferred embodiment of the present invention.

FIG. 2B is a simplified block diagram showing connection of a computing system to a printer, in accordance with a preferred embodiment of the present invention.

FIG. 3 is a simplified block diagram showing service monitor, communication service, XMPP clients and restart service, in accordance with a preferred embodiment of the present invention.

FIG. 4 is a table containing some key values, descriptions thereof, along with sample values for the keys, in accordance with a preferred embodiment of the present invention.

FIG. 5 is a simplified block diagram showing application server, device management, communication service, public network, XMPP server, and printing devices, in accordance with a preferred embodiment of the present invention.

FIG. 6 is a flowchart showing the processes and steps of the service monitor and the communication service, with possibly starting and/or restarting of the communication service, in accordance with a preferred embodiment of the present invention.

FIG. 7 in part shows the steps S1, S2, and S3 within the inter-workings of the communication service and the monitoring service, in accordance with a preferred embodiment of the present invention.

FIG. 8 is a block diagram that shows the time-sequence or chronological sequence of actions and interactions among the components, in accordance with a preferred embodiment of the present invention.

FIG. 9 shows sample monitoring requests formatted as XMPP message(s), in accordance with a preferred embodiment of the present invention.

### DETAILED DESCRIPTION OF THE INVENTION

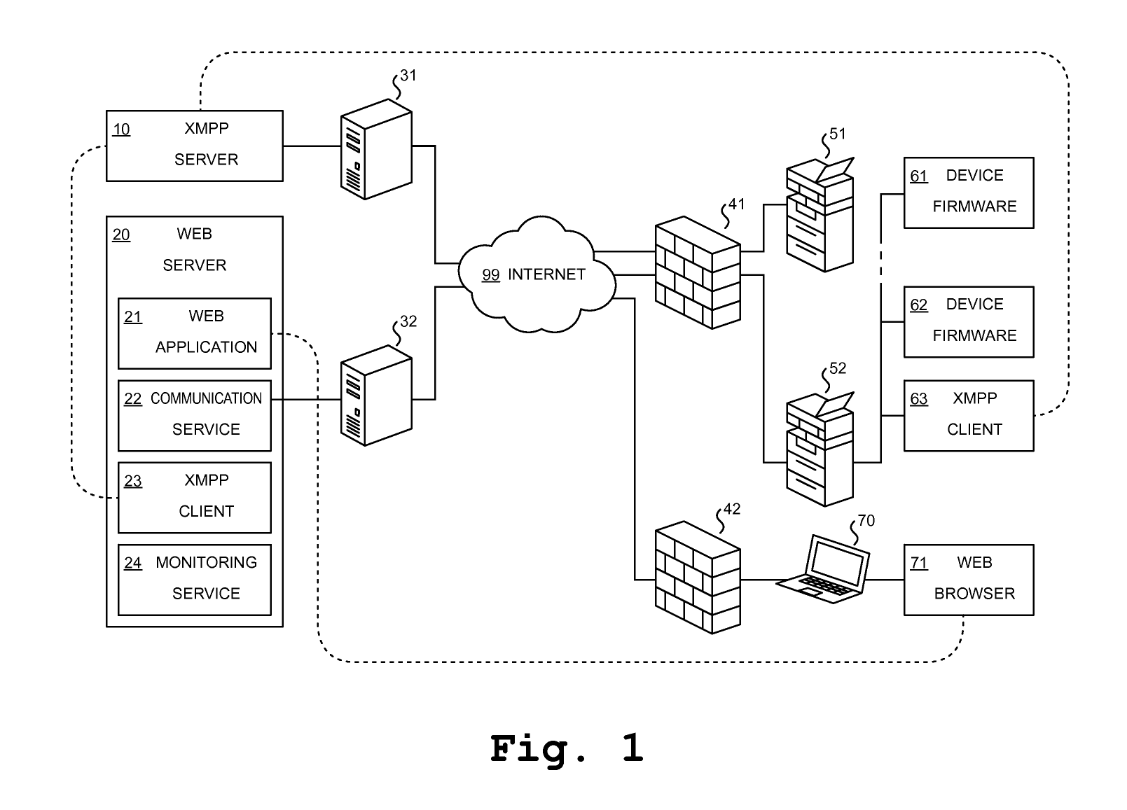

FIG. 1 is a simplified block diagram showing processing systems, components, and devices of a networked system, in accordance with a preferred embodiment of the present invention. A server computer or server machine 31 is connected to the Internet 99. The server computer (PC) 31 runs the XMPP server system or software 10. Another server computer or server machine 32 is also connected to the Internet 99. This server computer (PC) 32 runs the Web server system or software 20. The Web server system or software 20 includes or comprise of the following components: Web application 21, Communication service 22, XMPP client 23, and Monitoring service 60. Each of these components will be described in more detail in the later sections, in conjunction with later figures.

One or more printers or MFPs (multi-functional periphery or peripheries, Multifunctional Printers) 51, 52 are connected to the Internet 99 via a firewall 41. A printer or MFP 52, contains software comprising Device firmware systems 61, 62, and also an XMPP client 63. MFP devices are located in different local networks and different geographical locations. MFP devices may run different sets of firmware but are always able to support the XMPP communication protocol. Every MFP device connects to server machine 31 via Internet 99 by using XMPP client and XMPP protocol. Every MFP device also connects to server machine 32 via Internet 99 by using HTTP client and HTTP protocol.

A notebook/laptop PC or computer 70 is connected to the Internet 99 via a firewall 42. This computer 70 runs software, including or comprising a Web browser system or software 71. User computer connects to server machine 32 via Internet 99 by using Web browser.

In the figure (FIG. 1), dotted lines connect the XMPP server system or software 10 to the XMPP client 23, as well as the XMPP server system or software 10 to the XMPP client 63.

In one embodiment of the present invention, these dotted lines only represent a logical or virtual connection, since the actual connection between the XMPP server and the XMPP clients go through the Internet 99 that is represented in the figure.

In another embodiment of the present invention, these dotted lines represent a physical, alternate, or hybrid connections that comprise the actual connection between the XMPP server and the XMPP clients.

In a yet another embodiment of the present invention, these dotted lines represent a physical, alternate, or hybrid connections that compliment and work in conjunction with the connection established Internet 99 connection in a mutually-consistent manner, meaning that the alternate or hybrid connection operates in a consistent, non-conflicting manner with the Internet 99 connection.

In the figure (FIG. 1), another dotted line connects the Web application 21 (which is a component or sub-system of the Web server system or software 20) to the Web browser system or software 71 (which is a software running within the computer 70, or a notebook/laptop PC or computer 70 connected to the Internet 99 via a firewall 42).

In one embodiment of the present invention, this dotted line only represents a logical or virtual connection, since the actual connection between the Web application and the Web browser go through the Internet 99 that is represented in the figure.

In another embodiment of the present invention, this dotted line represents a physical, alternate, or hybrid connection(s) that comprise the actual connection between the XMPP server and the XMPP clients.

In a yet another embodiment of the present invention, this dotted line represents a physical, alternate, or hybrid connection that compliments and works in conjunction with the connection established Internet 99 connection in a mutually-consistent manner, meaning that the alternate or hybrid connection operates in a consistent, non-conflicting manner with the Internet 99 connection.

Further regarding FIG. 1, for a complex networked system such as that depicted in FIG. 1, reliability is of utmost importance. Reliability is definition of ability of a system or component to perform required functionality under specific conditions for a long period of time. Reliability is theoretically defined as the probability of failure over specific period of time. In this case ‘failure’ we define as a time when system is not available to perform required functionality. To minimize time when system or component is unavailable many engineering discipline offers mechanism of recovery. Recovery or self-recovery is a mechanism when system or component could start working again after failure.

Problem of reliability becomes more complicated when system compromised of multiple components. To increase system reliability, systems could be monitored by an external, independent component. The reason for this is that there is no guarantee that a system itself in its failed state can check that it is in a failed state. A system in a failed state is considered compromised, and all data coming from a compromised system can no longer be used. A failed state system cannot be assumed to put itself in a non-failed state. To handle this issue, an outside component must check on the system.

This usage of having a system monitor or system arbiter is used in various system designs seen in devices used in every day. This includes transportation devices such as cars and airplanes. Modern car engines are monitored by multiple micro-controllers. This redundancy allows for a chance failure in one of the micro-controllers to not cause damage to the car or the driver. The real world is filled with non-ideal scenarios, and all electronic devices have error or loss. Thus by having, the chance of a total failed system to occur will be lower. This is done by having an external monitor to ensure that the devices are in a proper running state by monitoring the data.

There is loss when converting signals from one form to another and when moving the signal, or data. This occurs when changing analog signals to digital signals, and even when changing mechanical energy into electrical. This can be seen in the inefficiency in collecting power, whether it is through a wind turbine, a water dam, or solar collectors, there are huge amounts of power loss in the energy capture. Data loss and energy loss are closely tied because data is stored in the form of energy. Data loss is on every level, and this leads to errors occurring. To handle these errors, we create various monitors to make sure that the system is not compromised, and if it is, to put it in a non-compromised state.

Since the Communication Service 22 deals with network data, there is a chance that the data may be invalid or received in an unexpected fashion. This may be due to network delay or abrupt network calls. Other points of failure may include input/output faults or bit parity being off due to network exchange. Error may occur because of separate hardware devices such as network cards, hard drives, and CPU. Errors may occur internally within a component such as the network card, the hard drive, or the CPU. There are many exceptions that occur behind the scenes of an operating system. There is no guarantee that the information will be perfect once the Communication Service 22 begins reading the information. Since the data being received by the Communication Service 22 is variable on all parameters including context and length of context, the restraints of determining if a command is valid or invalid is difficult to determine By having an inherit call that has precedence over all other calls, one can check if the service is still responding.

These heartbeat checks from the Communication Service 22 will allow for an external source to monitor the service. By having a monitor check on the service on a frequent basis, down-time will be mitigated because the time for the Communication Service 22 to be found in a failed state will be lowered. An external monitor is required because once the Communication Service 22 hits a failed state, it must be restarted.

It is hard to determine whether the connection between two devices is alive or not. The reason for this is that one device may have issues in responding due to network delays. Or a packet may be lost entirely during the transfer. Thus keep-alive signals, pings, or heartbeats must be used to determine whether the signal is still active. Since the XMPP server 10 and Communication Service 22 runs on different devices, then determining whether the connection has been disconnected is difficult without giving enough time. Because of so, sockets have a time-out time before it is released, or considered disconnected. This timeout time needs to be considered when listening to the heartbeat. The reason there needs to be a delay between checks is to give enough time to restart the service. In addition, there needs to be enough time to accept the response. Also, if the frequency of checks is too high, the number of actual task actions performed will be lower than desired. There needs to be a balance of how short the interval to check to determine the maximum throughput of data.

Note that from current testing data, it seems that the time-out interval to determine if the connection is stable is the constraint rather than throughput being the constraint. This is because the number of packets processed per second is relatively high, and the connection timeout is measured in multiple seconds rather than one second. There is a more than 100× difference in magnitudes.

In a networked system (FIG. 1), without network protocols, information being sent would be left encrypted, and thus useless. Network protocols are required to translate raw data into comprehensible data, similar to how computers decode the series of 0's and 1's into usable, representable data.

There are various communication protocols that have developed over the course of the past four decades. Each of these communication protocols are targeted at transferring different information. Such information includes but is not limited to files, text data, and general data. These protocols provide rules to exchange information and how to handle the information once received. Each of these protocols has their custom set of rules. Such sets include portions of how to deal with connecting to another node, how to transfer the information, how to read the information, and how to handle a disconnection. Most of these protocols were created when there was a void of another protocol. Each serves different purposes because they assume different environments. For example, FTP transfers files, and these connections may be severed at any given time. These severed file transfers may be resumed where it was left off once the connection is stable. On the other hand, HTTP does not have that reliability. It will send the data out once, if at all. This was not meant to have high data integrity.

There are various network protocols, each with their purpose of existence. One has to choose the one that makes the most sense for their application. Such things to consider include connection persistence, network reliability, packet throughput, packet size, and data integrity. By determining what attributes are important and which can be ignored, one can settle on which network protocol to use.

There is also the issue of choosing or using XMPP versus HTTP. The system that will be designed in the present invention and this document has the following attributes: unknown packet sizes, more often smaller packet sizes than larger packet sizes, higher number of packets, and a persistent connection. This would point to using either HTTP, due to unknown packet sizes. However, HTTP does not use persistent connections. Thus XMPP would be a better choice than HTTP. FTP would not be a good choice because the packet sizes are not large, and there are several packets.

Since HTTP allows for variable amount of data, the headers have to have the overhead for content-length and content type. Among the other attributes within the HTTP header are address, date, host, connection, from, expect, accept, accept-language, accept charset, accept-encoding, accept-datetime. All of these are unnecessary when two exact terminals are communicating to each other. This is unnecessary overhead, assuming the connection remains constant.

HTTP connections were originally designed to be a one-time packet. They were not designed to be a persistent connection. Noting how variable the data can be, one can see how a simple “hello” message of 5 bytes could be sent in a packet of 100 byte size to account for the encoding and language. The conversation between the two terminals can go on further. And the header information would be repeated with every dialogue. This repetition is unnecessary.

XMPP is a set of standards that allow variable data to be sent, without the unnecessary repetition of headers because it is assumed to be holding a persistent connection rather than opening and closing connection. This connection is done through a central server, which acts as an arbiter to send the data to the appropriate endpoint.

The XMPP protocol can be used on top of HTTP or over any other port. With that said, when XMPP is on a TCP/IP port, not necessarily port 80 (HTTP), it can open a single connection from any terminal to a central server. This connection can be maintained and held persistent, therefore the data of who is sending the data, what data encoding to use can be sent on initialization rather than on every packet send. This eliminates the unnecessary repetition of data, lowering network traffic. The data throughput becomes higher, especially for packets where the packet content is much smaller than the packet header. Not only does removing the header mean higher throughput because of less data on the line, but it means less data parsing overall. This improvement in throughput leads to less processing of the data to account for the header, such as removal of the header and processing of header data. This leads an improvement of processing and lowers network congestion.

XMPP allows for variable data and removes unnecessary repetition of data. To guarantee validity of data, it follows valid XML formatting of data. The server will not send out mal-formed XML data, and if it receives mal-formed XML data from a client, it will assume the connection to be bad and disconnect the client. The overhead for using XML data, as seen in XMPP, is smaller than the overhead from using the HTTP headers.

The only issue with downside of XMPP is that the initial cost for setting up the persistent connection is high. It is a series of handshaking that has to be done to guarantee validity and security. XMPP has all the benefits of using HTTP, with a higher throughput. By binding the XMPP to a non-HTTP port, it can drastically increase the throughput, especially of relatively small data. Since Communication Service 22 must be on at all times, a persistent connection makes sense. Therefore XMPP packets on a persistent connection should be used rather than HTTP packets sent because the one-time cost, even though higher, will be amortized. This makes the assumption that the number of packets per connection will be high, compensating for the connection cost.

There is a possible issue or problem with such a system. Each system has a decent uprate individually, but when communicating between each system, the success rate drops because the success rate of the whole process is the success rates of each system multiplied against each other. When one component of a subsystem fails, a subsystem fails. If a subsystem fails, the whole system fails.

For example, if for 10 systems within the process, each have a success rate of 99.9%, the success rate of the overall process of 10 systems drops to 99.0%. The monitoring system of the present invention is a large system, comprised of several smaller sub-systems. Communication Service 22 is one of the smaller sub-systems, which houses several different components. In order for the success rate to be 99.9% for the overall system, each subsystem must have a very minor room for error. Or several of the subsystems must be near perfect and one of them can have minor room for error.

A possible solution provided by the present invention for such a possible issue or problem with such a system is as follows. Getting the overall system to be near-perfect is difficult. To resolve the issue, an external component can check on subsystems. This will increase the reliability of the system because the only time where the whole system will fail is when both the external monitor and the subsystem being watch failed.

An example of how minimal the fail rate can be is if the external monitor fails only 0.1% and the subsystem fails 0.1%, the chance of failure is 0.01%. This can be improved upon by adding additional external monitors. Adding a second monitor with a fail rate of 0.1% to watch the subsystem will lead to an overall 0.001% chance of failure, assuming that the failure only can occur when all three fail. The probability percentages derived here assumes that false positives are negligible. A false positive would be when a monitor thinks the system is in the failed state when it actually is not. This assumption may be invalid during actual run-time. Note that as the number of monitors increase, the rate of false positive will increase.

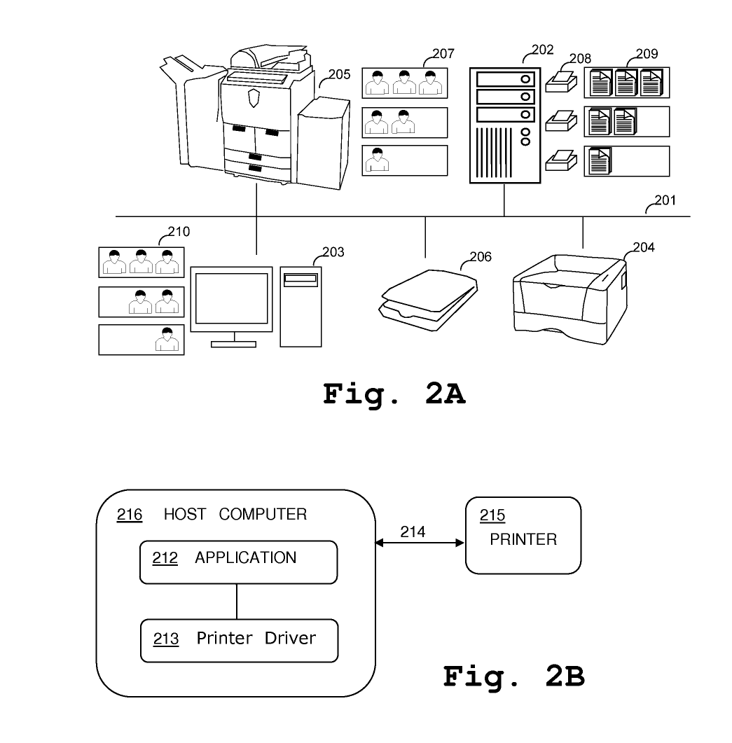

FIG. 2A is a simplified block diagram of document processing systems and devices on a network of an organization, in accordance with a preferred embodiment of the present invention. A network 201 interconnects several to possibly many computers and peripherals. Among them connected on the network there could be any number of personal computers 203, shared servers 202, scanners and scanning devices 206, such networked printing devices as smaller or simpler printers 204, and multifunctional peripherals (MFPs) 205. For a device management system to be truly efficient, it is not sufficient to operate only physical devices, but it is necessary to operate device related objects, which are more specific to the functions of the devices. For example, on personal computers 203 there are typically any number of users 210 authorized to access services of the personal computers and other networked document processing system resources, such as servers 202. On networked printing devices there are typically several accounts 207; and among shared servers 202 there could be print spool servers with many print queues 208 and queued, processed or running print jobs 209. The present invention enables efficient management of many such printing device related objects.

FIG. 2B is a simplified block diagram showing connection of a computing system to a printer, in accordance with a preferred embodiment of the present invention. FIG. 2B shows a general printing system setup that includes a host computer 216 and a printer 215. Here, the printer 215 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 216 includes an application 212 and a printer driver 213. The application 212 refers to any computer program that is capable of issuing any type of request, either directly or indirectly, to print information. Examples of an application include, but are not limited to, typically used programs such as word processors, spreadsheets, browsers and imaging programs. Since the invention is not platform or machine specific, other examples of application 212 include any program written for any device, including personal computers, network appliance, handheld computer, personal digital assistant, handheld or multimedia devices that is capable of printing.

The printer driver 213 is a software interfacing with the application 212 and the printer 215. Printer drivers are generally known. They enable a processor (microprocessor, micro-processor; also sometimes called CPU or central processing unit), such as a personal computer and within a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 214 is provided and permits host computer 216 to communicate with a printer 215. Printer 215 is configured to receive print commands from the host computer and, responsive thereto, render a printed media. Various exemplary printers include laser printers that are sold by the assignee of this invention. The connection 214 from the host computer 216 to the printer 215 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer drivers, and it is also suited for other device drivers. The above explanations regarding FIG. 2B used a printer driver rather than a general device driver for concreteness of the explanations, but they also apply to other device drivers. Similarly, the following descriptions of the preferred embodiments generally use examples pertaining to printer driver, but they are to be understood as similarly applicable to other kinds of device drivers.

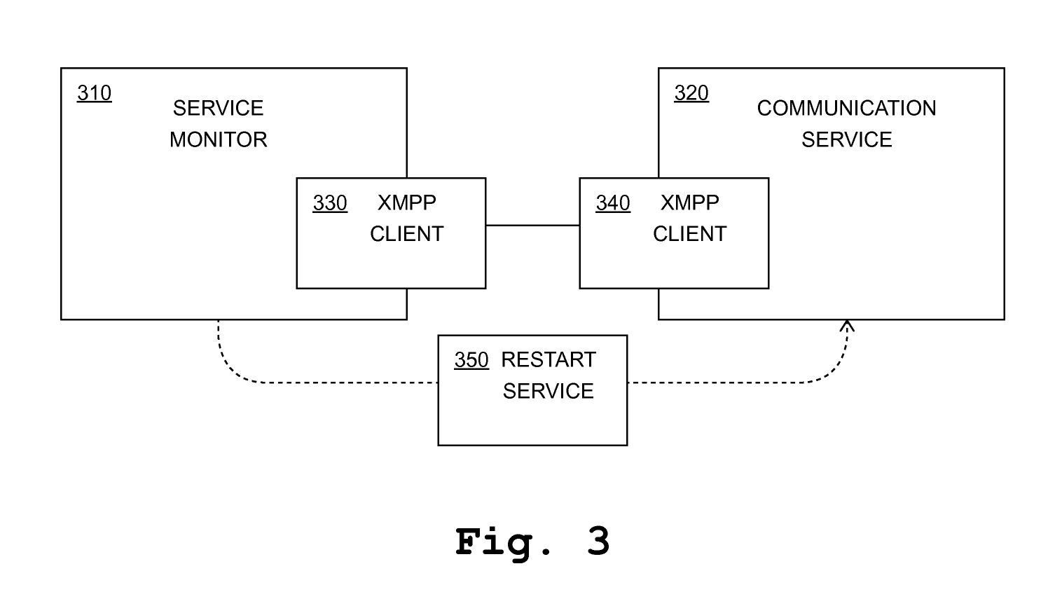

FIG. 3 is a simplified block diagram showing service monitor, communication service, XMPP clients and restart service, in accordance with a preferred embodiment of the present invention.

TMMS Manager (the manager of the monitoring system of the present invention) (server side) has several Windows services running independently from the web applications. The most vital service is Communication Service 320, which supports XMPP communication, email notifications and scheduled tasks.

If Communication Service 320 is unresponsive, TMMS Manager (the manager of the monitoring system of the present invention) will be dysfunctional. To monitor if this service is always responsive, we want to add a small application that can monitor Communication Service 320 periodically.

When setting up the Service Monitor 310, a task must be created within the Task Scheduler. Service Monitor 310 starts running periodically by Task Scheduler (not shown in FIG. 3). How often it runs and when it starts is configurable via the Task Scheduler. The Service Monitor 310 may be run manually by starting the application. It will run exactly the same as it would if it was set up to run periodically via the Task Scheduler. Multiple instances of the Service Monitor 310 with the same user and resource should not be started, as one of the users will log the other use out, causing one to fail and forcing a restart of the service.

After Service Monitor 310 starts, Service Monitor sends XMPP message to the Communication Service 320. This is done through the XMPP clients 330, 340. The Communication Service 320 will respond to the XMPP with the appropriate response. If the appropriate response is not received within a configurable interval, then Communication Service 320 is deemed unresponsive and must be restarted 350. The application will attempt to restart the service, first by stopping it if possible and then starting the service. Note that there is a requirement that the Ejabberd server must be active in order to run this, as that is the XMPP server. Without the XMPP server being on, this service will fail and force a restart of Communication Service.

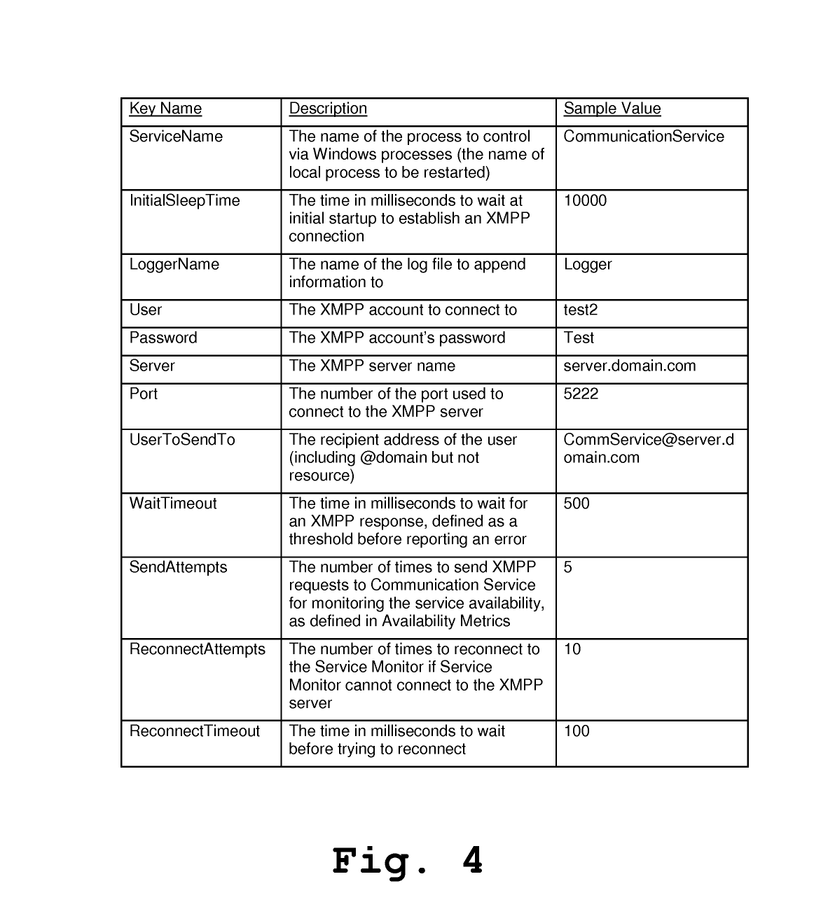

FIG. 4 is a table containing some key values, descriptions thereof, along with sample values for the keys, in accordance with a preferred embodiment of the present invention. This table shows a typical configuration of values and setup in accordance with a preferred embodiment of the present invention. Key values are also known as attribute names, property labels, slot titles, etc.

ServiceName is the name of the process to control via Windows processes (the name of local process to be restarted), for which a typical, usual, or sample value is CommunicationService.

InitialSleepTime is the time in milliseconds to wait at initial startup to establish an XMPP connection, for which a sample value is 10000.

LoggerName is the name of the log file to append information to, for which a sample value is Logger.

User is the XMPP account to connect to, for which a sample value is test2.

Password is the XMPP account's password, for which a sample value is Test.

Server is the XMPP server name, for which a sample value is server.domain.com.

Port is the number of the port used to connect to the XMPP server, for which a sample value is 5222.

UserToSendTo is the recipient address of the user (including @domain but not resource), for which a sample value is CommService@server.domain.com.

WaitTimeout is the time in milliseconds to wait for an XMPP response, defined as a threshold before reporting an error, for which a sample value is 500.

SendAttempt is the number of times to send XMPP requests to Communication Service for monitoring the service availability, as defined in Availability Metrics, for which a sample value is 5.

ReconnectAttempts is the number of times to reconnect to the Service Monitor if Service Monitor cannot connect to the XMPP server, for which a sample value is 10.

ReconnectTimeout is the time in milliseconds to wait before trying to reconnect, for which a sample value is 100.

In another embodiment of the present invention, such a typical key-value table (a table containing some key values, descriptions thereof, along with sample values for the keys) would also include or comprise the following. IP is the IP of the server, for which a sample value is 69.42.25.195. Resource is a resource for the user to log in as and use (make sure this is unique), for which a sample value is “ping_the_service”. MaxNodeResourcesToSend is the maximum number of times to ping the server, for which a sample value is 1.

In a yet another embodiment of the present invention, such a typical key-value table would also include or comprise the following. SleepTime is the number of milliseconds to wait after initial startup, for which a sample value is 10000. LoggerName is the log file to which information is appended, for which a sample value is Logger. Server is the name of the server's domain, for which a sample value is user0-2.doc-server.com. IP is the IP address of the XMPP server, for which a sample value is unspecified or 11.11.11.111. Resource is a resource for the user to log in to and use, for which a sample value is ping_the_service. Port is the port number used to connect to the XMPP server, for which a sample value is 5222. UserToSendTo is the recipient e-mail address of the user, for which a sample value is test245@user0-2.doc-server.com. WaitTimeout is the number of milliseconds to wait before reporting a connection error, for which a sample value is 500. ReconnectAttempts is the number of times to reconnect the monitor service before reporting a connection error, for which a sample value is 10. ReconnectTimeout is the number of milliseconds to wait before trying a reconnect to a service, for which a sample value is 100.

Note that the total run-time will be the connection time added to the product of WaitTimeout and SendAttempts. Maximum Run-time=SleepTime+(ReconnectAttempts×ReconnectTimeout)+(WaitTimeout×SendAttempts)

This section and the following descriptions are on process, processes, and processing within or of the Service Monitor of the present invention. This section contains details on the algorithm that the Service Monitor of the present invention uses. Note that logging information is done during the following steps, but is not discussed in this section.

Regarding the generic process, the following is a generic process overview with the configuration names instead of any direct value.

(1) Monitor Service is started.

(2) Wait for a period of {SleepTime}

(3) Attempt to connect to XMPP server as {User}@{Server}/{Resource} with the password {Password} up to {ReconnectAttempts} times. Wait {ReconnectTimeout} before trying another attempt.

(4) Once connection is made, send a message to {UserToSendTo}/node-01 up to and including {UserToSendTo}/node-{MaxNodeResourcesToSendTo}. Wait {WaitTimeout} between each message for a response. Send up to {SendAttempts} messages.

(5) If no response, or if all responses are errors, restart the {ServiceName}.

(6) Otherwise end Monitor Service

Some examples follow. With the sample values given in the configuration section, the prior will look like:

(1) Monitor Service is started.

(2) Wait for a period of 10 seconds (10000 ms)

(3) Attempt to connect to XMPP server as test@user0-2.doc-server.com/ping_the_service with the password “Test” up to 10 times. Wait 0.1 seconds before trying another attempt.

(4) Once connection is made, send a message to test245@user0-2.doc-server.com/node-01 up to and including test245@user0-2.doc-server.com/node-01. Wait half a second between each message for a response. Send up to 5 messages.

(5) If no response, or if all responses are errors, restart the CommunicationService.

(6) Otherwise end Monitor Service

Regarding logging the results of monitoring, this uses the KYOCERA XmppTCPClient object inside the XMPP.dll. This means that it has additional logging parameters specifically for XMPP data. These are found within the log4net files that correspond to the nodes with the name ClientAppender and StreamAppender. By default, these will be created as additional log files within the same folder as the LogAppender unless otherwise changed.

The LogAppender log will show the logs specific to this application, ServiceMonitor (Service Monitor of the present invention). This includes starting the application and closing the application. This will log if there were any responses (Responding) or if there were no responses (No response). The log will also have details of the data in each packet received. It will say who the packet was sent to (the full Jid). If the service is not responding, the ServiceMonitor (Service Monitor of the present invention) will log an attempt at restarting the service, including stopping and starting.

The ClientAppender log will correspond to the connecting, sending, and receiving of packets. This will have logs of full packets being sent and received.

The StreamAppender log will correspond to the live data being received. This will include details of bytes being ignored and how each is processed. This will show how data is read and how packets are made.

Regarding checking of the Service Monitor of the present invention, if there is a line with only the text “Responding”, the service is working. If there is a line with only the text “No response”, the service has failed to respond and must be restarted. Note: all logs are prefixed with the timestamp.

There are additional log statements to tell what is happening. Reconnecting, disconnected, and connecting are some keywords that will show up in the log.

The log will also include the packets being received (the whole XMPP packet, not just the context). This can be used to determine what state the ServiceMonitor (Service Monitor of the present invention) is in. If an error message is received, that is most likely because the service is not on. If no packet is received, then the service is in a failed state.

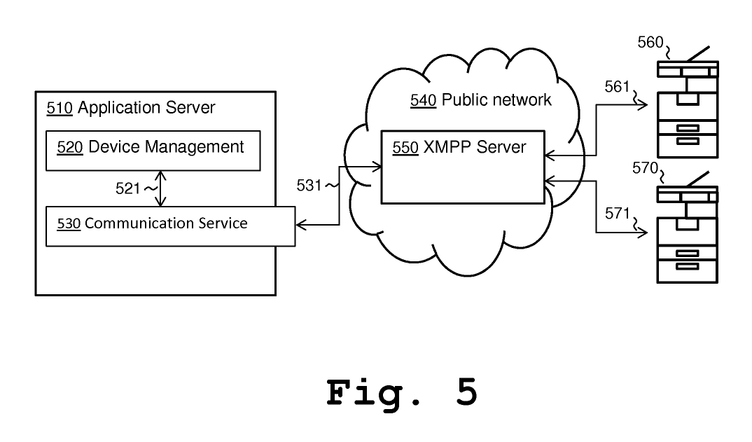

FIG. 5 is a simplified block diagram showing application server, device management, communication service, public network, XMPP server, and printing devices, in accordance with a preferred embodiment of the present invention.

Continuing with the description of the present invention disclosing methods and systems for monitoring communication (XMPP) based services, presented methods comprise a method for monitoring a communication based system, monitoring the availability and response time. Collecting data with thresholds on metrics on a periodic basis and each time a communication performance metric gets below or above some threshold, triggering reboot the service. Calculating new thresholds of system resource/performance metrics to be used for monitoring.

The most important thing when running a Communication Service 530 that supports connections between many devices and one central server is to provide continuous communication at a level of service which is available for a long time with minimum of downtime when the service is unavailable. Ability to provide communication service 530 in most cases defined as a ration between time when system in available for operation and downtime, when system is not functional.

Application server 510 comprises software and systems comprising device management 520 and communication service 530. Public network 540 comprises software and systems comprising XMPP server 550. Connected through and via the public network 540 are one or more printing devices 560, 570. One or more printers or MFPs (multi-functional periphery or peripheries, Multifunctional Printers) 560, 570 are connected to the Internet (Public network 540), possibly via a firewall or firewalls. Each printer or MFP 560, 570, contains software comprising Device firmware systems, and also an XMPP client.

To provide high level of availability requires the communication service 530 to be running for as long time as it possible and in case if it's not available—to identify the problem as soon as possible. Typically, when a communication service 530 has a problem: responses are timed out, new connection cannot be established, etc., the process of restoration needs to begin and statistics of communication problems (events) collected.

To identify situation when the communication service 530 is not functioning as expected we suggest using an external component that can monitor Communication Service 530 via XMPP connection.

An external, independent component can identify when Communication Service 530 is not available by sending periodical messages to Communication Service 530. Monitoring time interval could be adjusted per specific environment and based on statistics collected over time. The reasons to use external component to monitor status of Communication Service 530 are twofold:

1. Generally speaking, the system itself in its failed state can check that it is in a failed state. A system in a failed state is considered compromised, and all data coming from a compromised system can no longer be used. A failed state system cannot be assumed to put itself in a non-failed state. To handle this issue, an outside component must check on the system.

2. By having monitoring time interval short enough—status when Communication Service 530 is unavailable could be identified in very short time interval.

In terms of system monitoring, there are two distinct areas of an external monitoring: (A) monitor if service is running, and (B) monitor service via communication protocols and messages.

There are many approaches to monitor service availability, of which one preferred approach is: monitoring a service as executable resource under current OS (operating system). One preferred way and method is to monitor services as a running process by checking list of running processes under Operation System (or operating system such as Linux, Windows, etc.).

```
    // Get all instances of the service running on the local computer.
Process [ ] processByName =
Process.GetProcessesByName(“TheService”);
    // get general statistics
var processTime = processByName[0].TotalProcessorTime;
var processTime = processByName[0]..VirtualMemorySize64
```

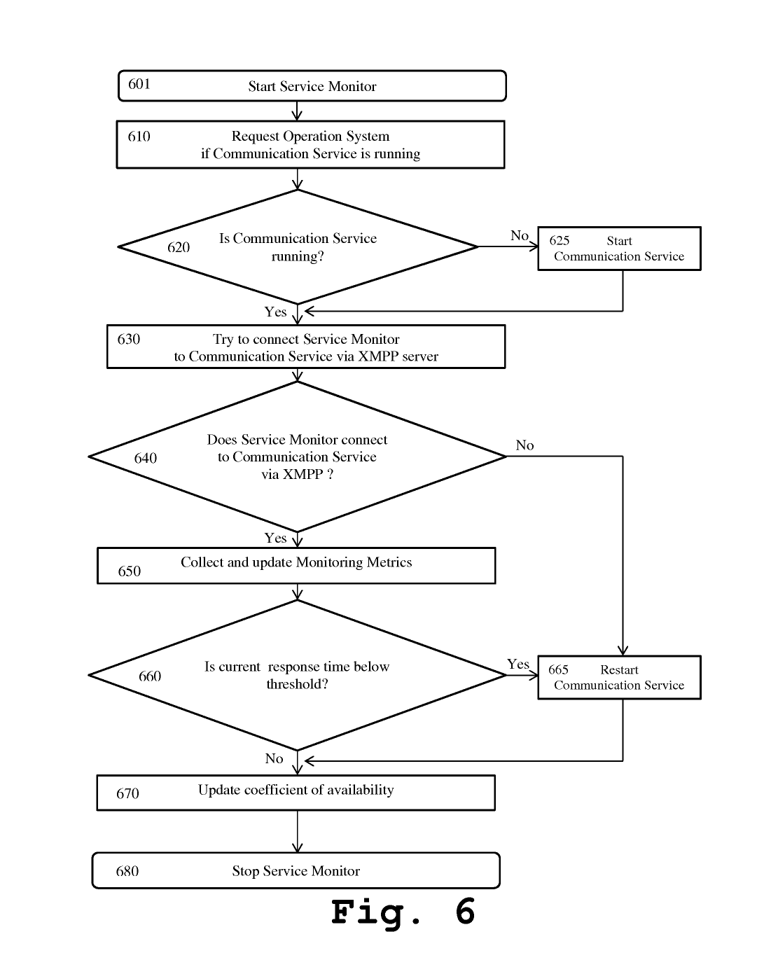

FIG. 6 is a flowchart showing the processes and steps of the service monitor and the communication service, with possibly starting and/or restarting of the communication service, in accordance with a preferred embodiment of the present invention.

In Step 601, the Service Monitor starts running periodically as a scheduled process. Time interval or time intervals (at) when Service Monitor starts running is a configurable parameter and normally could be between 1 and 5 minutes.

In Step 610, the Service Monitor requests the Operation System (or operating system) via programming interface if Communication Service is running as a process. The Communication Service has a specific name of its process and operation system populates list of all running processes.

In Step 620, a determination is made to see if the Communication Service is running. If the Communication Service is not running, then Service Monitor starts the Communication Service by requesting the Operation System to run the Communication Service as a process. In Step 625, the Communication Service starts running if it was not started yet.

In Step 630, the Service Monitor needs to be connected to running the Communication Service in order to exchange XMPP messages. The Service Monitor is trying to establish an XMPP connection with the Communication Service.

In Step 640, a determination is made to see if the Service Monitor connects to the Communication Service via XMPP. If the Service Monitor cannot connect to the Communication Service via XMPP, then Service Monitor restarts Communication service (in Step 665) and updates statistics regarding availability of Communication Service. In case if the Service Monitor successfully connects to Communication Service via XMPP—restart is not needed and the Service Monitor sends XMPP requests to the Communication service.

In Step 650, the Service Monitor sends XMPP monitoring requests to the Communication Service and collects responses. Response time and data in monitoring responses gets collected into the Monitoring Metrics.

In Step 660, a determination is made to see if the current Performance Metrics (response time) is below the threshold. If the response time is getting below the threshold, the Service Monitor restarts the Communication service (in Step 665). In this and other decision step (or a determination step), a comparison is made between two values, or a testing of a condition is performed using a micro-processor.

In Step 670, based on information of when the Communication Service needed to be restarted and Monitoring Metrics, the coefficient of availability gets updated.

In Step 680, the Service Monitor process described in this flowchart (FIG. 6) is completed and stopped.

The state of running process under OS could be: running or stopped. But behavior of running process under OS could be different based on many factors: amount of available resource, number of back-end/database transactions etc. Result of monitoring a running service as executable resource in current OS could be inaccurate in terms of if Communication Service needs to be restarted even it looks like an executable process.

Disadvantage of this approach is possibility that when the process is running—functionality over XMPP communication could be unavailable due to slowness or resource limitations (sockets, memory etc).

Since the Communication Service deals with network data, there is a chance that the data may be invalid or received in an unexpected fashion. This may be due to network delay or abrupt network calls. Other points of failure may include input/output faults or bit parity being off due to network exchange.

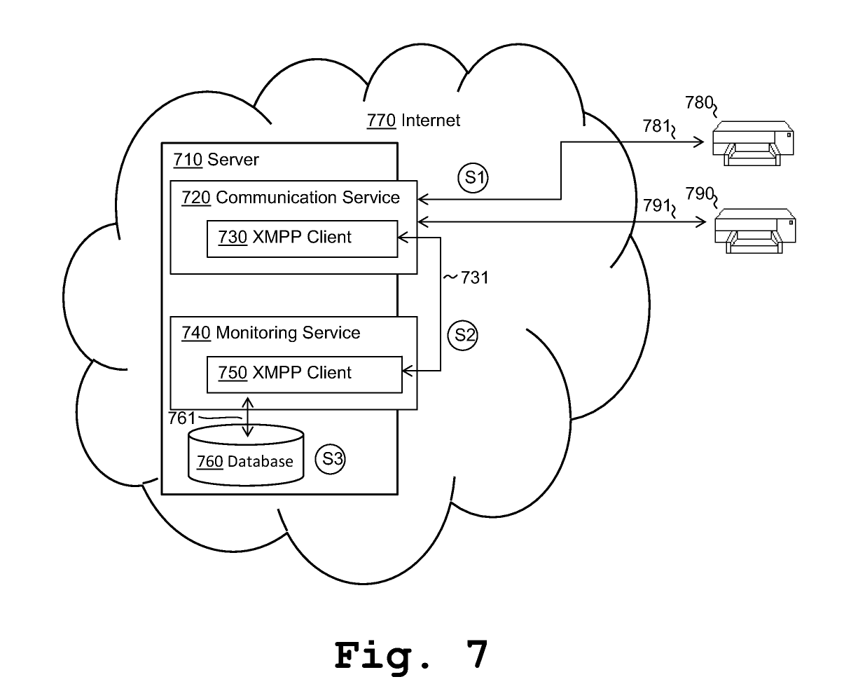

FIG. 7 in part shows the steps S1, S2, and S3 within the inter-workings of the communication service and the monitoring service, in accordance with a preferred embodiment of the present invention. The following steps S1, S2, and S3 are shown in FIG. 6 as the circled S1, S2, and S3.

S1. Communication service 720 provides long-time running XMPP-based connections between server-side Device Management application and remote devices 780, 790. Communication Service 720 is part of Device Management application. Device Management application is a web-based application to control Devices 780, 790 remotely. Communication Service 720 needs to be available for maximum long time. If Communication Service 720 is unavailable for any reason it needs to be re-started as soon as possible.

For example: If availability needs to be A=99.99% (4-nines), downtime needs to be only 52 minutes/year

To calculate availability of the Communication Service 720, we can use following values: MTBF (Mean time between failures) and MTTR (Mean time to repair).

A=MTBF/(MTBF+MTTR)

For software components MTBF means—the time between sequential reboots of the software component [#2]. This interval needs to be calculated from the monitoring (analytical) metrics.

Note that MTTR includes the following:
Time wasted in activities aborted due to Communication Service 720 cannot process any message do to software errors
Time wasted do to network problems
Time taken to detect signal processor failure
Time taken by the failed processor to reboot and come back in service
   First two items could be detected only by sending XMPP requests and receiving responses between Communication Service 720 and Monitoring Service.

S2. If Communication service 720 needs to be monitored from outside (outside of its process) then Communication Service 720 needs to supports external API, we suggest to use XMPP-based API. This monitoring API could provide short term statistics: Monitoring service 740 uses or consumes XMPP-based API to retrieve short term statistics: <get number of messages for past 10 minutes>

S3. Monitoring service 740 saves collected data in database 760 and processes a monitoring matrix. This saved data is used later by the analytical component to decide whether to restart the communication service. These decisions need to be made based on information (statistics) collected about Communication Service. This information gets retrieved from XMPP requests and saved in the database. The format of this saved data, as well as the manner in which this data is stored, are described and specified elsewhere in conjunction with the other aspects of the present invention.

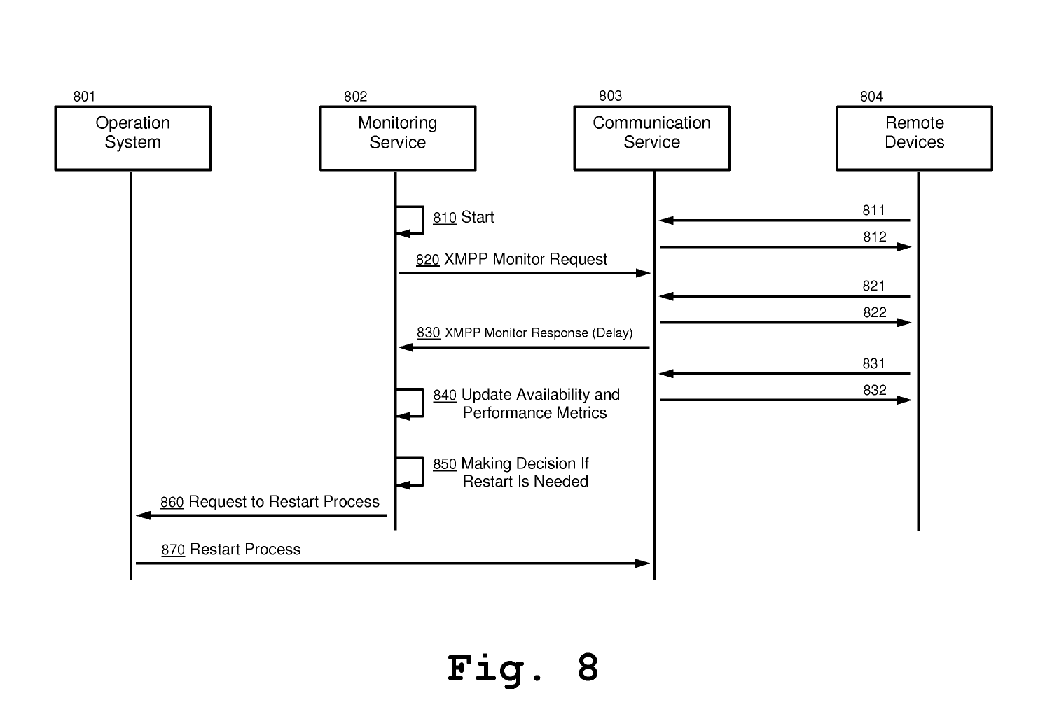

FIG. 8 is a block diagram that shows the time-sequence or chronological sequence of actions and interactions among the components, in accordance with a preferred embodiment of the present invention. In a preferred embodiment of the present invention, there are monitoring requests and responses, collecting availability metrics: normal case (no reboot needed).

The sequence and the sequence steps are as follows. To sum up and give an overview of the following sequence steps, in step 810 the monitoring service 802 starts, and (in step 820) sends XMPP monitor request. In step 830, the monitoring service 802 receives XMPP monitor response (possibly after a potential delay) from the communication service 803. In step 840, the monitoring service 802 updates availability and performance metrics 840. In step 850, the monitoring service 802 is making decision if restart is needed. In step 860, the monitoring service 802 sends request to the operation system 801 a request to restart process. In step 870, the operation system 801 initiates a restart process, and reports it to the communication service 803.

(Sequence step 1). Communication Service 803 keeps XMPP connection with remote devices 804 all possible time. Communication Service 803 runs one instance (node) of XMPP client and communicates with multiple devices 804 over long period of time. Communications between Communication Service 803 and Remote Devices 804 (right side of the diagram) are happening often and continuously (811, 812, 821, 822, 831, 832) and number of processed messages (work load) cannot be precisely predicted. In case if Communication Service 803 is not available to send and receive XMPP messages—it should be restarted by external component. After restart of Communication Service 803, all connections and communication will be recovered.

(Sequence step 2). Monitoring Service 802 runs its own instance of XMPP client. Monitoring Service 802 is able to establish AMPP connection with Communication Service 803 and send XMPP messages to Communication Service 803 periodically and receive responses back.

(Sequence step 3). Both Communication Service 803 and Monitoring Service 802 support XMPP-based API to exchange messages in format of Monitoring Request and Monitoring Response. Format of these messages could vary, samples of Monitoring Request and Monitoring Response is described below. The main purpose to use Monitoring API is to measure and collect an Availability and Performance metrics.

(Sequence step 4). Availability and Performance Metrics consists of information collected from Monitoring Responses. Availability and Performance Metrics could be used for future analysis and for making a decision to restart Communication Service 803. Threshold values can be customized by settings and configurations the administrators.

(Sequence step 5). Time interval between Monitoring Service 802 connects to Communication Service 803 and sends XMPP requests to Communication Service 803—is defined in configuration settings and could be changed anytime. In most cases the time interval could be set between 1 and 5 minutes.

The rule to change time interval between XMPP monitoring requests based on following: identify any problem with Communication Service 803 as soon as possible AND minimize work-load of the Communication Service 803. Also, the rule could be based on collected statistics (matrix): 1. During low-load time the monitoring service 802 could be started/activated not very often. 2. When Communication Service 803 expected to be under high load—Monitoring Service needs to be active more often.

(Sequence step 6). Monitoring Service 802 sends XMPP requests that have specific format. Communication Service 803 can process these requests with specific format. We define XMPP format of Monitoring Requests as Monitoring API. The format consists at least two parts: (a). Monitoring Request with name of command to receive performance metrics; (b). Monitoring Response that includes data of performance metrics.

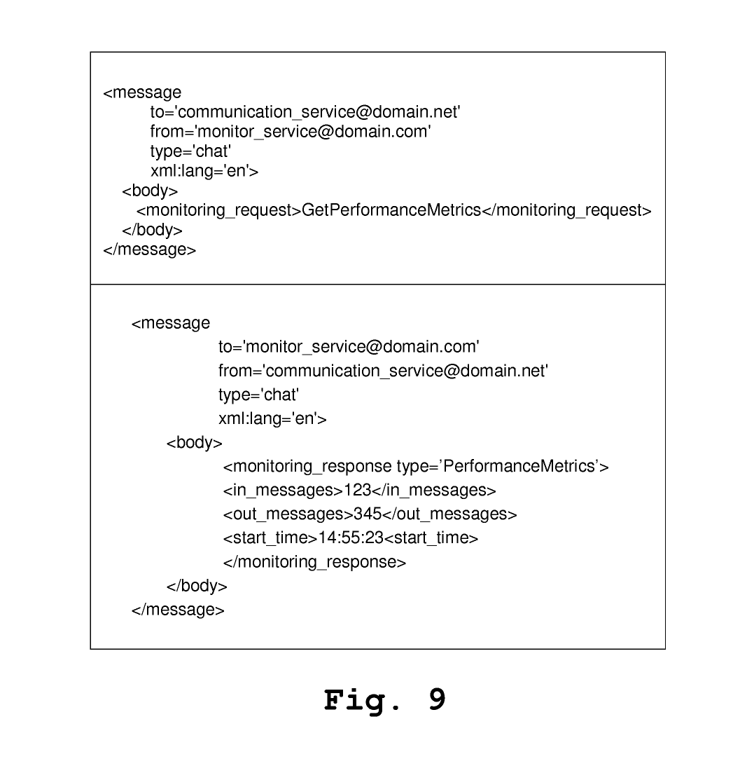

FIG. 9 shows sample monitoring requests formatted as XMPP message(s), in accordance with a preferred embodiment of the present invention. A monitoring Request formatted as XMPP message but inside of <body/> tag has additional <monitoring_request> tag (the top half, or the first part, of the sample monitoring requests in FIG. 9 and the code fragment(s) below). A monitoring Response is placed inside on <body/> tag and could have following format and data (the bottom half, or the second part, of the sample monitoring requests in FIG. 9 and the code fragment(s) below). XMPP-formatted message acts as an envelope to deliver ‘monitoring’ requests and responses. The “domain.com” is an example of a domain host name. Each of customers or users who use this invention would be expected to set up their own domain host name.

```
<message
    to=‘communication_service@domain.com’
    from=‘monitor_service@domain.com’
    type=‘chat’
    xml:lang=‘en’>
  <body>
    <monitoring_request>GetPerformanceMetrics</monitoring_request>
  </body>
</message>
  <message
        to=‘monitor_service@domain.com’
        from=‘communication_service@domain.com’
        type=‘chat’
        xml:lang=‘en’>
      <body>
        <monitoring_response type='PerformanceMetrics'>
        <in_messages>123</in_messages>
        <out_messages>345</out_messages>
        <start_time>14:55:23<start_time>
        </monitoring_response>
      </body>
        </message>
```

(Sequence step 7). When Monitoring Service 802 sends Monitoring Request to Communication Service 803 it expects to receive response back. By retrieving XMPP response—Monitoring Service collects an availability and performance metrics and passes the data to Analytical Metrics

Availability and Performance Metrics consists of information collected from Monitoring Responses, which is shown in the following Table of performance data included in Monitoring Responses.

| Request | Response | Analytical Metrics |
|---|---|---|
| GetNumberOfMessages | Number of messages | This metrics allows |
| | processed by Commu- | building a daily |
| | nication Service for | statistics it terms |
| | past time interval (it | of work load. It |
| | could be one hour, or | could be used to |
| | less) | predict high load |
| | | peaks in a future. |
| GetAnalyticalMetrics | Response could include | |
| | performance/statistics | |
| | data, for example: min- | |
| | imum and maximum of | |
| | response time, average | |
| | of response time etc. | |

(Sequence step 8). There are two kinds of data that needs to be collected from Monitoring Response and stored in performance metrics: (i). Response time of Monitoring Response after Monitoring Service 802 sends Monitoring Request. (ii). Data that included in Monitoring Response (table ‘performance data’). This data is supported by special API that Communication Service 803 needs to implement in terms of be able monitored. Format of data and API could vary by specific implementation but general format is mentioned above (message format). Statistics over weeks, days . . . predict restarts.

(Sequence step 9). If Communication Service 803 does not send Monitoring Response back or the response comes back with significant delay (based on metrics or threshold)—then Monitoring Service 802 could make a decision to restart Communication Service 803. The decision to restart Communication Service 803 could be made based on following factors:

(a). Communication Service 803 does not send back responses for 3-5 sequential Monitoring Requests. Monitoring Requests were sent by Monitoring Service 802 with specific time interval (see above table).

(b). Communication Service 803 sends back responses with significant delay—delay could be defined as a threshold based on analytical matrix and current work load.

(c). Based on collected statistics Communication Service 803 needs to be restarted after certain time interval (one a day, once a week). This time interval could be calculated based on collected statistics, for example: Communication Service 803 having slower responses after peak load during several hours or continuous normal work during one week

(Sequence step 10). Downtime will be minimized by restarting Communication Service 803 and making it available as soon as possible. Downtime includes following time intervals. (a) Communication Service 803 was not available prior to Monitoring Service 802 identified the problem. (b) Monitoring Service 802 making a decision to restart Communication Service 803. (c) Communication Service 803 got restarted and is back to a normal work.

Summarizing and summing up, what is presented in an embodiment of the present invention is a method for monitoring communication based service, monitoring their availability and response time, collecting statistics and calculating metrics, said method comprising the steps of:

The communication service 803 supports XMPP-based API that provides short term statistics including: number of received messages for past specific interval time (and possibly some or any other).

The monitoring service 802 uses or consumes XMPP-based API and periodically requests short term statistics in advanced sending request with specific time interval data to be collected.

The monitoring service 802 measures response time upon above mentioned request.

The monitoring service 802 collects statistics and calculated baily basis matrix including: number of messages received on time period based and response time for each request.

The collected data stored in monitoring service database.

Calculating the mean value for each system resource or transaction performance metric of merged data;

identifying the metrics for which there is a significant difference between mean value obtained with triggering or without triggering;

according to the identified metric mean value, calculating new thresholds of system resource metrics to be used for monitoring.

Regarding the Service Monitor and the Analytical Component, in some specific cases the Communication Service needs to be restarted. The Service Monitor makes a decision when to restart the Communication Service. These decisions need to be made based on information (statistics) collected about Communication Service. This information gets retrieved from XMPP requests and saved in database. The Analytical Component is responsible for collecting information about status of the Communication service and providing this information when it is needed. Information that the Analytical Component collects and handles includes the Availability and Performance metrics. The Availability metrics presents percentage of time when the Communication Service is available, comparing to (in comparison to, or relative to) the time when the Communication Service is unavailable or shut down. The Performance metrics presents number of messages processed in unit of time and response time of the Communication Service.

In a preferred embodiment of the present invention, the monitoring service component does not merely watch one or more processes (the nature of these processes are described just below), and the monitoring service component does not merely monitor one or more processes using communication API, and the monitoring service component communicates with the communication service component using by sending and receiving one or more XMPP messages, each of the one or more XMPP messages comprising a real command, which is sent and its result is received by the monitoring component.

In an embodiment of the present invention, this means that the monitoring service component does not merely watch one or more processes as running instance under Operating System or as one or more running processes in a memory.

In another embodiment, this means that the monitoring service component does not merely watch processes as one or more running processes in a memory.

In another embodiment, this means that the monitoring service component does not merely watch processes as real-time process/thread activity.

Whenever there is a decision made during a process or procedure (such as when indicated by a rhombus shaped box in a flowchart), the deciding or determining step involves comparing, checking, correlating, and/or analyzing of two or more elements or values using a micro-processor.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although the terminology and description of this invention may seem to have assumed a certain platform, one skilled in this art could see how the disclosed methods can be used with other operating systems, such as Windows, DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A method for monitoring a communication-based system, comprising:
providing a communication-based system comprising a communication service component that supports XMPP-based communication with one or more remote devices, which communication service operates in conjunction with one or more device management applications;
providing an external, independent monitoring service component that monitors the communication-based system comprising the communication service component;
providing an XMPP client corresponding to the communication service component, and an XMPP client corresponding to the external, independent monitoring service component;
establishing an XMPP connection between the XMPP client corresponding to the communication service component and the XMPP client corresponding to the external, independent monitoring service component;
the monitoring service component communicating with the communication service component using XMPP by sending and receiving one or more XMPP messages through the XMPP connection between the XMPP client corresponding to the communication service component and the XMPP client corresponding to the external, independent monitoring service component; and
providing an analytical component connected to the monitoring service component monitoring the communication-based system comprising the communication service component, which analytical component analyzes (using a microprocessor) the one or more XMPP messages to determine status of the communication-based system comprising the communication service component.

2. The method of claim 1, wherein each of the one or more XMPP messages comprises of a message in a specially-defined XMPP format of monitoring requests as monitoring API, which XMPP format comprises: a monitoring request with name of command to receive performance metrics, and a monitoring response that comprises data of performance metrics.

3. The method of claim 1, wherein the monitoring service component does not merely watch one or more processes as a running instance under the operating system and the monitoring service component does not merely watch one or more processes as one or more running processes in a memory;
the monitoring service component does not merely monitor one or more processes using communication API; and
the monitoring service component communicates with the communication service component using by sending and receiving one or more XMPP messages, each of the one or more XMPP messages comprising a real command, which is sent and its result is received by the monitoring component.

4. The method of claim 1, wherein the monitoring service component sends and receives one or more XMPP messages, which are monitoring request formatted as XMPP messages, wherein inside of <body> tag comprises additional and special <monitoring_request> tag as <monitoring_request>GetPerformanceMetrics</monitoring_request>, and wherein inside of <body> tag comprises additional and special <monitoring_response> tag as <monitoring_response type, ‘PerformanceMetrics’> <in_messages>[in messages]</in_messages> <out_messages>[out messages]</out_messages> <start_time>[start time]<start_time> </monitoring_response>.

5. The method of claim 1, wherein the analytical component analyzes the one or more XMPP messages to determine status of the communication-based system, which analytical component monitors the availability matrix, availability and response time, and if the analytical component determines that the current response time is below a pre-determined and customizable threshold, the service Monitor restarts the communication service.

6. The method of claim 5, wherein the analytical component bases its decision according to the previously saved statistical data archived in the database, which statistical data comprising information about the communication service, previously retrieved from XMPP requests and saved in database, which information collected and handled by the analytical component comprises availability and performance metrics,
which availability metrics comprises percentage of time when the communication service is available, in comparison to the time when the communication service is unavailable or shut down, and
which performance metrics comprises number of messages processed in a unit of time and response time of the communication service.

7. A computing system for monitoring a communication-based system comprising a communication service component that supports XMPP-based communication with one or more remote devices, comprising:
providing a communication-based system comprising a communication service component that supports XMPP-based communication with one or more remote devices, which communication service operates in conjunction with one or more device management applications;
providing an external, independent monitoring service component that monitors the communication-based system comprising the communication service component;
providing an XMPP client corresponding to the communication service component, and an XMPP client corresponding to the external, independent monitoring service component;
establishing an XMPP connection between the XMPP client corresponding to the communication service component and the XMPP client corresponding to the external, independent monitoring service component;
the monitoring service component communicating with the communication service component using XMPP by sending and receiving one or more XMPP messages through the XMPP connection between the XMPP client corresponding to the communication service component and the XMPP client corresponding to the external, independent monitoring service component; and
providing an analytical component connected to the monitoring service component monitoring the communication-based system comprising the communication service component, which analytical component analyzes (using a microprocessor) the one or more XMPP messages to determine status of the communication-based system comprising the communication service component.

8. The computing system of claim 7, wherein each of the one or more XMPP messages comprises of a message in a specially-defined XMPP format of monitoring requests as monitoring API, which XMPP format comprises: a monitoring request with name of command to receive performance metrics, and a monitoring response that comprises data of performance metrics.

9. The computing system of claim 7, wherein the monitoring service component does not merely watch one or more processes as a running instance under the operating system and the monitoring service component does not merely watch one or more processes as one or more running processes in a memory;
the monitoring service component does not merely monitor one or more processes using communication API; and
the monitoring service component communicates with the communication service component using by sending and receiving one or more XMPP messages, each of the one or more XMPP messages comprising a real command, which is sent and its result is received by the monitoring component.

10. The computing system of claim 7, wherein the monitoring service component sends and receives one or more XMPP messages, which are monitoring request formatted as XMPP messages, wherein inside of <body> tag comprises additional and special <monitoring_request> tag as <monitoring_request>GetPerformanceMetrics</monitoring_request>, and wherein inside of <body> tag comprises additional and special <monitoring_response> tag as <monitoring_response type, ‘PerformanceMetrics’> <in_messages>[in messages]</in_messages> <out_messages>[out messages]</out_messages> <start_time>[start time]<start_time> </monitoring_response>.

11. The computing system of claim 7, wherein the analytical component analyzes the one or more XMPP messages to determine status of the communication-based system, which analytical component monitors the availability matrix, availability and response time, and if the analytical component determines that the current response time is below a pre-determined and customizable threshold, the service Monitor restarts the communication service.

12. The computing system of claim 11, wherein the analytical component bases its decision according to the previously saved statistical data archived in the database, which statistical data comprising information about the communication service, previously retrieved from XMPP requests and saved in database, which information collected and handled by the analytical component comprises availability and performance metrics,
which availability metrics comprises percentage of time when the communication service is available, in comparison to the time when the communication service is unavailable or shut down, and
which performance metrics comprises number of messages processed in a unit of time and response time of the communication service.

13. A computer program product stored in a non-transitory computer-readable medium for monitoring a communication-based system comprising a communication service component that supports XMPP-based communication with one or more remote devices, comprising machine-readable code for causing a machine to perform the method steps of:
providing a communication-based system comprising a communication service component that supports XMPP-based communication with one or more remote devices, which communication service operates in conjunction with one or more device management applications;
providing an external, independent monitoring service component that monitors the communication-based system comprising the communication service component;
providing an XMPP client corresponding to the communication service component, and an XMPP client corresponding to the external, independent monitoring service component;
establishing an XMPP connection between the XMPP client corresponding to the communication service component and the XMPP client corresponding to the external, independent monitoring service component;
the monitoring service component communicating with the communication service component using XMPP by sending and receiving one or more XMPP messages through the XMPP connection between the XMPP client corresponding to the communication service component and the XMPP client corresponding to the external, independent monitoring service component; and
providing an analytical component connected to the monitoring service component monitoring the communication-based system comprising the communication service component, which analytical component analyzes (using a microprocessor) the one or more XMPP messages to determine status of the communication-based system comprising the communication service component.

14. The computer program product of claim 13, wherein each of the one or more XMPP messages comprises of a message in a specially-defined XMPP format of monitoring requests as monitoring API, which XMPP format comprises: a monitoring request with name of command to receive performance metrics, and a monitoring response that comprises data of performance metrics.

15. The computer program product of claim 13, wherein the monitoring service component does not merely watch one or more processes as a running instance under the operating system and the monitoring service component does not merely watch one or more processes as one or more running processes in a memory;
the monitoring service component does not merely monitor one or more processes using communication API; and
the monitoring service component communicates with the communication service component using by sending and receiving one or more XMPP messages, each of the one or more XMPP messages comprising a real command, which is sent and its result is received by the monitoring component.

16. The computer program product of claim 13, wherein the monitoring service component sends and receives one or more XMPP messages, which are monitoring request formatted as XMPP messages, wherein inside of <body> tag comprises additional and special <monitoring_request> tag as <monitoring_request>GetPerformanceMetrics</monitoring_request>, and wherein inside of <body> tag comprises additional and special <monitoring_response> tag as <monitoring_response type, ‘PerformanceMetrics’> <in_messages>[in messages]</in_messages> <out_messages>[out messages]</out_messages> <start_time>[start time]<start_time> </monitoring_response>.

17. The computer program product of claim 13, wherein the analytical component analyzes the one or more XMPP messages to determine status of the communication-based system, which analytical component monitors the availability matrix, availability and response time, and if the analytical component determines that the current response time is below a pre-determined and customizable threshold, the service Monitor restarts the communication service.

18. The computer program product of claim 17, wherein the analytical component bases its decision according to the previously saved statistical data archived in the database, which statistical data comprising information about the communication service, previously retrieved from XMPP requests and saved in database, which information collected and handled by the analytical component comprises availability and performance metrics,
which availability metrics comprises percentage of time when the communication service is available, in comparison to the time when the communication service is unavailable or shut down, and
which performance metrics comprises number of messages processed in a unit of time and response time of the communication service.
